(19) United States
(12) Patent Application Publication
(10) Pub. No.: US 2015/0012459 A1
(43) Pub. Date: Jan. 8, 2015

(54) Computerized stock market investment decision-making for individual stocks

(71) Applicant: Stanley M. Burnstein, Overland Park, KS (US)

(72) Inventor: Stanley M. Burnstein, Overland Park, KS (US)

(21) Appl. No.: 13/317,721

(22) Filed: Oct. 26, 2011

(51) Int. Cl. G06Q 40/06

(52) U.S. Cl. 705/36 R

(57) ABSTRACT

A computer-implemented interactive method to help an investor in the decision-making process of evaluating what securities to buy and sell, and when to buy and when to sell, and when to be out of the market, for an actively-managed portfolio of individual stocks. The method provides individualized advice based upon input by the User/Investor and operates under the supervision of a Registered Investment Advisor. The process evaluates and scores the upside potential and the downside risk of a given stock, along with the investor's temperament to be in the market.

### BACKGROUND

An investor, who desires to buy or sell individual stocks, has a variety of choices in determining how to carry on the decision-making process. There are a variety of financial products, many of them proprietary and many of them sold or available by financial advisors. There are also a variety of newsletters, and companies operating through the internet that provide recommendations as to stocks to buy and to sell, but rarely with individualized input by the User/Investor.

There are many strategies available to the investor and the advisor who may be providing recommendations to the investor. Some of the methodologies include fundamental analysis, which is to evaluate investments based upon earnings, sales, financial strength, with significant emphasis on the financial statements, including Profit and Loss, Balance Sheet, and Cash Flow Statements, and quality of management.

There are other methods of analysis which include technical analysis which is based primarily on the trends of price movement and volume of trades of the stock. Technical analysis is also based on a study of price and volume information, numerous derivative techniques including the advance/decline ratio, and relative strength index. These technical indicators place significant emphasis on the quantity (volume) of securities traded during a particular time period as well as the price and price trend. Normally, the technical analysis does not make specific reference to earnings, book value, quality of management or other items considered in the fundamental analysis described above.

The present invention relies primarily on fundamental analysis.

Some of the alternatives to direct purchase of stocks for the User/Investor include the purchase of mutual funds, which have the benefit of pooled investments, but such investments do not have the ability to provide individualized investment management. For those investors willing to delegate investment responsibility to others, a money manager can be hired to manage the investments. Another problem that the invention is designed to solve is that neither a mutual fund nor money manager is hired to advise the investor when to be out of the market, as traditionally, the fund or money manager stays fully invested.

The investor is faced with a maze of alternatives for investment strategy, including daily trading and long-term investing (the latter being sometimes referred to as “Buy and Hold”). The result is that the small investor needs individualized advice and a coach to help with the discipline and stamina to buy when others are selling and to sell when others are buying. For the individual investor making his own investment decisions, this becomes a real challenge. The invention is designed to help meet this challenge.

Another problem is that there is no one objective method for analyzing stocks, inasmuch as the subject of stock analysis is highly subjective, and efforts to make it objective require arbitrary allocations of weight to varying factors, many of which may relate to prior history. Since the decision-making process is highly subjective, investors and advisors use a variety of shortcuts to help transform what is essentially a subjective matter into arbitrary formulas. However, no one such formula can cover all the possible situations, and there is no agreement in the investment community as to how much weight is to be given to varying factors, including how much weight to give to historical information. Thus, it is essential that any practical formula make use of certain basic tools, and that the decision as to such tools be credible and reasonable. The design of the invention assumes that it is essential to consider estimated future earnings and future cash flow and not merely historical information.

Prior art does not appear to include a practical formula with investor input, with a comprehensive practical interactive computerized formula based primarily upon estimated future earnings as a tool to make more informed investment decisions. To help solve this problem, the goal of the current invention is to assist the investor to analyze estimated future earnings as a factor in helping to determine if the current stock is underpriced and to provide significant emphasis on the following:
1. Measuring the upside potential, by considering various factors, including questions and responses to and from the investor in helping to determine whether the stock is under-priced.
2. Measuring the downside risk, by measuring various factors, including whether the company has minimal debt, significant cash, and other evidence of low risk.
3. Measuring the temperament of the investor by considering a variety of factors, including the emotional ability of the investor to stand firm in a down market and to be a contrarian who can act contrary to what others are doing.

It is submitted that the invention solves many of these problems, has practical application and provides a novel, useful, concrete and tangible result with the appropriate electronic tools.

The applicant presently contemplates the use of the interne as a method of transmission of information, but other methods of transmission and communication to the User/Investor or to the User/Investor's computer, with responses by a computer program, may be utilized.

In making the analysis, the invention may provide varying weight to each of the various responses given by the investor in response to questions submitted to him or her that are proffered to the User/Investor, including the User/Investor's evaluation of estimated future earnings and reasonable price/earnings multiples (ratio of the current stock price to estimated earnings per share). The invention is an effort to provide a score that includes considerable weight to the above factors. The invention includes as one of its features an effort to determine the future value of the Targeted Stock and compare that value to the current price or proposed purchase price to help determine if the stock is significantly underpriced.

In his analysis of other sources, including prior art and existing patents, the applicant has found no other interactive program or algorithm or method which provides a recommendation from a Registered Investment Advisor to an User/Investor utilizing the User/Investor's own input of information about a particular Targeted Stock, along with information about the User/Investor's own evaluation of factors that impact the upside potential, the downside risk, and the User/Investor's tolerance to be in the stock market.

Using the methods described herein, the User/Investor must score well for his Targeted Stock in each of the steps in order to receive a passing recommendation for that stock. The design is such that a high score in one area will not make up for a low score in another area. This is because the scores are not averaged; they are multiplied one against the other. So if a person has a score of 100 on Step 1 and 100 percent on Step 2 and a score of 50 percent on Step 3, then when these are multiplied by each against the other, the total score is 50, which is not acceptable for making a purchase. Thus, this method of scoring is novel, unique, and of value. Such method does not seem to appear in the prior art. The questions presented and the steps taken in Steps 1, 2 and 3 are also unique and useful to advance the art of useful information for an investor in analyzing a given stock. Much of the prior art deals with providing an array of stocks through selection of various mutual funds for investment by the User/Investor's pension plan.

Any prior art that the applicant has examined in general is less specific than the invention, and as a result, makes use of a lesser degree of User/Investor input. In addition, any prior art that does not require use of a Registered Investment Advisor for the giving of individualized advice may not be in compliance with the Rules of the Securities and Exchange Commission which require registration and licensing for persons who provide individualized investment advice.

Prior art typically makes no mention of when to sell. The embodiment herein solves that problem by giving the User/Investor advice about what to buy, when to buy, what to sell, when to sell, and when to be out of the market.

The invention requires substantial input from the User/Investor, followed by an individualized response to investor input, along with recommendations, which require that the automated computerized interactive response be managed or supervised by an investment advisor registered with the Securities & Exchange Commission. Thus, the analysis herein and the transmission over the Internet or otherwise are all based on the assumption that it will be under the supervision of a Registered Investment Advisor.

### SUMMARY OF THE INVENTION

The invention is designed for the User/Investor, to have a tool to help the User/Investor in the selection of stocks to be purchased and stocks to be sold. Unlike other inventions in the field, each User/Investor makes his or her own decision as to the purchase and sale of stock, based upon the responses that the User/Investor receives from the Registered Investment Advisor after the User/Investor provides certain “input” into the system. The program does not, on its own, select stocks to be considered. Quite the contrary, it allows the User/Investor to select stocks which are to be analyzed according to the software formula in the processor or other electronic device so as to provide an analytical tool to the User/Investor during the decision-making process.

First, the User/Investor will be asked to either select a particular stock to be considered as a Targeted Stock, or to “screen” for stocks to consider that will meet certain objectives, using commercially available stock screens. There are a multitude of screening processes available through the internet that are available to the User/Investor. Websites such as the Finance site at Yahoo.com provide fundamental information and stock screening tools. Also, many websites, including the above Finance site, provide stock screens based upon fundamentals. Fundamental characteristics are described in books such as The Intelligent Investor by Benjamin Graham (1965, Harper & Row, New York) and its Fourth Revised Edition (1973, Harper & Row, New York), with new commentary by Jason Zweig (2003, Harper Business Essentials, New York) and Beating the Street by Peter Lynch (1994, Simon and Schuster, New York).

Fundamental analysis requires that investment decisions be made from a variety of financial data, including but not limited to, sales, book value, earnings per share, dividends, current price, and estimated future growth, but not using the “charts.” Charts typically reflect price action and volume and not earnings.

The present invention does not attempt to provide, on its own, a system for initial screening. It merely suggests that the screening process take place prior to the submission of targeted stocks for evaluation by the computerized software program in order to enhance the possibility that the Targeted Stock will receive a favorable rating. The stocks to be analyzed by the computerized software program would then be entered into the User/Investor's electronic device such as a computer along with the current market price of the stock (or the desired purchase price or desired sale price), and an estimate of the subsequent year's estimated earnings, and an estimate of the future annual growth rate in the earnings per share, for the purpose of helping to measure the upside potential of a given stock. The above response is provided by the User/Investor in response to questions proffered to the User/Investor by the Registered Investment Advisor via the internet or other electronic communication device. The responses then go back through the system to the Registered Investment Advisor, with an interactive response to the User/Investor for the completion of step one. These same estimates can be analyzed via a computer managed by a Registered Investment Advisor, with or without utilizing the internet. The Registered Investment Advisor may utilize a website as a location for the User/Investor to go to for accessing the algorithm in the computerized software program, under the supervision of the Registered Investment Advisor.

Step 1 attempts to place a future value on the Targeted Stock and then compares that value with the current market price of the stock, to see if the Targeted Stock is out of sync (undervalued). Value under the invention is a function of present price, estimated future earnings, cash flow, and a reasonable price/earnings ratio. Prior history is of lesser importance. Prior price action and volume of trades as reflected in the “charts” are not determining factors in measuring the upside potential or the downside risk of the Targeted Stock.

Subsequently, in Step 2 the User/Investor provides input through the system via the interne or other electronic communication device with answers to various questions tendered to the User/Investor by the Registered Investment Advisor. After transmitting the responses to the questions to the Registered Investment Advisor from the User/Investor, the User/Investor is supplied with a score for the purpose of measuring the down-side risk of the particular stock being analyzed.

Step 3 attempts to measure the investor's temperament for dealing with the market as well as his or her suitability for being in the market. Accordingly, the User/Investor is asked to respond to a series of questions, such as questions relating to the investor's liquidity, diversification, sophistication, years to retirement, and other matters that do not relate to a particular stock, but to the ability of the User/Investor to emotionally deal with the risk of being in the stock market, to stand firm, to be a contrarian, to live without substantial anxiety during a down-market, and to have the guts to buy in a down-market and to sell in an up-market. This step three is also scored.

In providing an analysis or summary back to the User/Investor in the form of a relative score, there are a variety of factors utilized by the software, including an assignment of various weights to various factors that are not necessarily equal in value. Also, the scores are not averaged. A formula is utilized which includes a weighting given to various factors. In addition, the formula provides some adjustments both upward and downward in the scoring to take into consideration a need to score high enough in each of the three steps to help offset the fact that a substantial failure in one step cannot be made up with high scores in the other steps. Additional adjustments are made so that a score of one hundred is a neutral score.

The User/Investor is given the opportunity to review the score and re-assess the responses and make his or her own decision as to the purchase or sale of the Targeted Stock.

There will be times when the market in general will be over-priced, in which case it will be very difficult to find stocks that qualify for the necessary score to justify a purchase. Conversely, when the market is generally low, there may be a greater number of stocks available for suggested purchase under this system. The algorithm will help the User/Investor in making the decision of whether to buy or sell and at what price.

Since the software operates under the assumption that at varying times, a particular stock may be over-priced or under-priced, it assumes that the “efficient market theory” may not always prevail, especially on small capitalization companies where fewer shares are traded and where the price may be “out-of-sync” from what might normally be considered a reasonable value. See Zweig's commentary to Graham's book, The Intelligent Investor, (described above) page 213.

The efficient market theory assumes that the public price is a fair market value, as that is what the public has determined. Our belief is to the contrary.

The software utilizes current and estimated future financial data, along with personal non-financial information about the User/Investor and information regarding his or her temperament to be in the market submitted by the User/Investor, to provide a useful analysis back to the User/Investor to act as a tool to help the User/Investor make more analytical type decisions and to help steer the investor away from allowing his or her emotions to control the decision-making process.

Different financial products and tools place varying emphasis on the various tools and different weight as to the comparative values of those tools. In comparing the invention with prior art, the invention appears to be novel, useful and unique in that none of the prior art appears to allow the investor a shortcut to receiving advice where it takes into consideration: (a) the input from the investor as to several aspects of a stock which are ordinarily highly subjective; (b) a determination of an estimate of the future value of the stock; (c) the comparison of the calculated future value to the current price of the stock; (d) the measurement of the downside risk of that same stock; (e) self-evaluation by the User/Investor to help evaluate whether the User/Investor has the stamina and discipline and ability to act in the face of contrary recommendations by so-called experts. The program does not provide “Buy and Hold” recommendations. It requires that the investor be an active trader. When the stock is over-priced, the investor is urged to sell.

It is submitted that the above combination of factors is not in a single package, formula or algorithm available in a software package or on the internet, recognizing that such a program is an individualized program, in that the investor's input is required and thus requires that it be operated under the supervision of an investment advisor registered with the Securities and Exchange Commission. A core belief underlying the invention is that ultimately, future earnings will determine value. However, those stocks with the highest earnings potential and the highest estimated growth potential, may, on occasion, be the same stocks that have substantial downside risks or they may be over-priced. Accordingly, downside risk is a key ingredient in measuring under the invention. However, as indicated by Jason Zweig, in his 2003 update of Graham's book, The Intelligent Investor, the biggest risk is “the investor himself,” who will be prone to do the wrong thing at the wrong time. Thus, the invention takes that into consideration by attempting to measure the investor's discipline and ability to act as “contrarian” (to act contrary to the action of the public).

It is submitted that no other technique takes into consideration the key components described herein.

Another unique ingredient of the invention is that it makes an effort to estimate a future value of a Targeted Stock and then compares that future value to today's price and allows the investor to compare it with a proposed purchase or sale price, to compare the future value to the present price, to see if there is sufficient spread to warrant a purchase, or to the contrary, may warrant a sale.

Contrary to other techniques currently available in the prior art, no effort is made to create an index fund or a similar fund that would be electronically traded that would mimic many of the traits of a particular stock index.

Among the other factors considered in the invention is that the age of the investor and the amount of cash available and the number of years to retirement are also factored into, determining the number of points given toward the recommendation of a particular purchase. Most investors have no meaningful strategy, and to the extent that they do, many of them lack the discipline to follow through on any such strategy. The invention suggests that the investor use the invention as a crutch in helping the investor make better stock market decisions.

One of the benefits of the method is to be able to not only use it as a tool to evaluate what to buy, what to sell, when to buy, and when to sell, but also to determine when to be out of the market. The latter category of being out of the market is tied to a point in time when there are no stocks than can be found that are under-priced, or at such times that all of the stocks that are being evaluated are over-priced, that being the mantra for determining when to be out of the market. Another factor in being out of the market is when the investor does not have the temperament to be a contrarian and other attributes considered necessary to be a stock market investor.

Note also that for each of the categories described above, a number of variations are also available.

The above description is evidence that the invention solves a known problem with produced advantages not expected by the prior art. In addition, the above is evidences of non-obviousness and addresses a long-felt need in the art for a solution to a known problem and failure of others to solve that known problem.

The invention can be used in a software package on a computer or it can be used on the internet or at a website. The drawings are based upon use of the internet, although the claims are not limited to the use of the internet as the method for using the invention.

The applicant has found no patent which provides an automated response from the Registered Investment Advisor, based upon individualized information from the User/Investor which provides recommendations for the purchase or sale of individual stocks, based upon the User/Investor's input, with results taking into consideration the reasonableness of price, estimated future earnings, upside potential, downside risk, and the temperament of the User/Investor.

While the above description has been presented for purposes of illustration and contains many particular uses, these should not be construed as limitations on the scope of any embodiment, but as exemplifications of various embodiments thereof.

Thus the scope should be determined by the appended claims and their legal equivalents, and not by the examples given.

Many variations and modifications of the embodiment may be apparent to one of ordinary skill in the art, in light of disclosures described above. The scope of the invention is to be defined as described herein and by their equivalents. Specifically, in the description, the computer program code has been described in such a manner so that those skilled in the art will understand. However, the computer code may be structured differently without deviating from the scope of the invention. In addition, the particular order of the sequence of the steps set forth in the specifications should not be construed as a limitation, inasmuch as those skilled in the art will understand that different sequences of steps are possible without deviating from the scope of the invention. Even though the invention provides for sequential processing, users should understand that many of the processing steps that are performed in a sequential pattern may also be performed or rearranged into alternative sequences. These alternatives are meant to be part of the scope of the invention described herein.

### BRIEF DESCRIPTION OF THE DRAWINGS

FIG. 1 is a chart of the questions to be answered on an electronic device, such as a computer, tablet, or telephone, as part of the process for measuring the upside potential of a given Targeted Stock.

FIG. 2 shows two flowcharts: One reflects the transfer of information from the User/Investor to the Registered Investment Advisor, and the second reflects the transfer from the Registered Investment Advisor to the User/Investor via an electronic device, such as a computer, tablet, smartphone, and communicated by electronic transfer, such as over the interne.

FIG. 3 is a formula for the calculation of the score by the Registered Investment Advisor's electronic device, such as a server, for Step 1 (measuring upside potential)

FIG. 4 illustrates a second set of questions, along with a rating to be determined by the User/Investor in an effort to measure the downside risk of the Targeted Stock.

FIG. 5 is an algorithm measuring the downside risk through a set of calculations.

FIG. 6 is a questionnaire for use in Step 3 as a method for measuring the temperament of the User/Investor.

FIG. 7 is a formula used in connection with measuring the temperament of the User/Investor, to be a patient and unemotional investor.

FIG. 8 is a formula for the calculation of the weighted score.

FIG. 9 is an interpretation of the score, along with the rating for the stock.

### DESCRIPTION OF THE EMBODIMENT

### Introduction.

The invention may be understood by those skilled in the art by reference to the drawings.

The method described herein is not limited to use on an internet but could be utilized as a software package on a computer that operates under the supervision of a Registered Investment Advisor.

The invention is not limited to 3 Steps, as additional steps may be added from time to time.

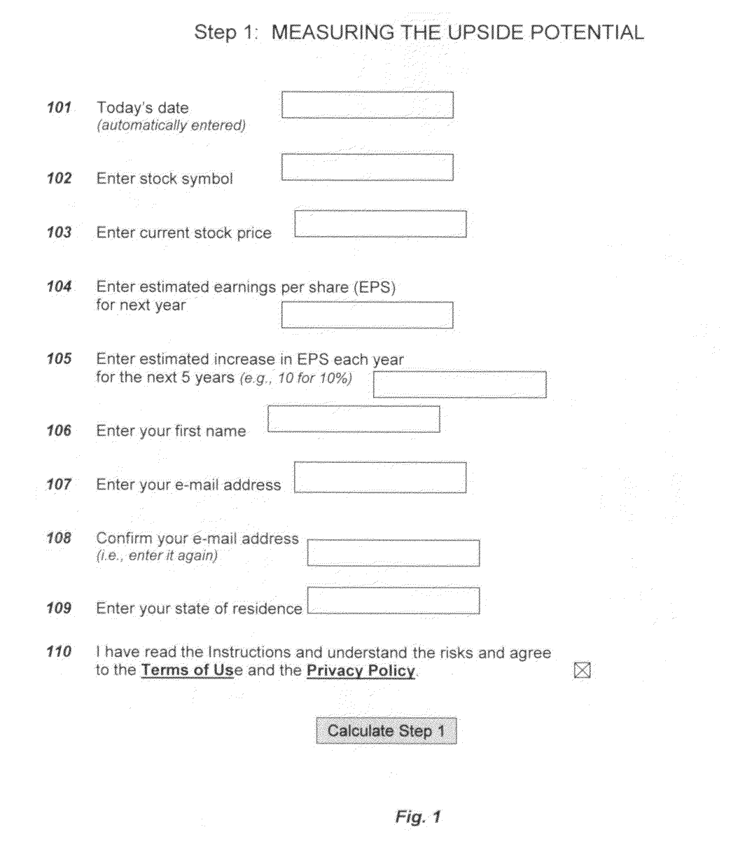

Starting at the beginning of the software program, which can be at the website of the Registered Investment Advisor, the User/Investor is confronted with a form as shown in FIG. 1.

The User/Investor then fills in the answers to questions 101 through 110 by entering the appropriate responses in the boxes to the right. The questions may vary.

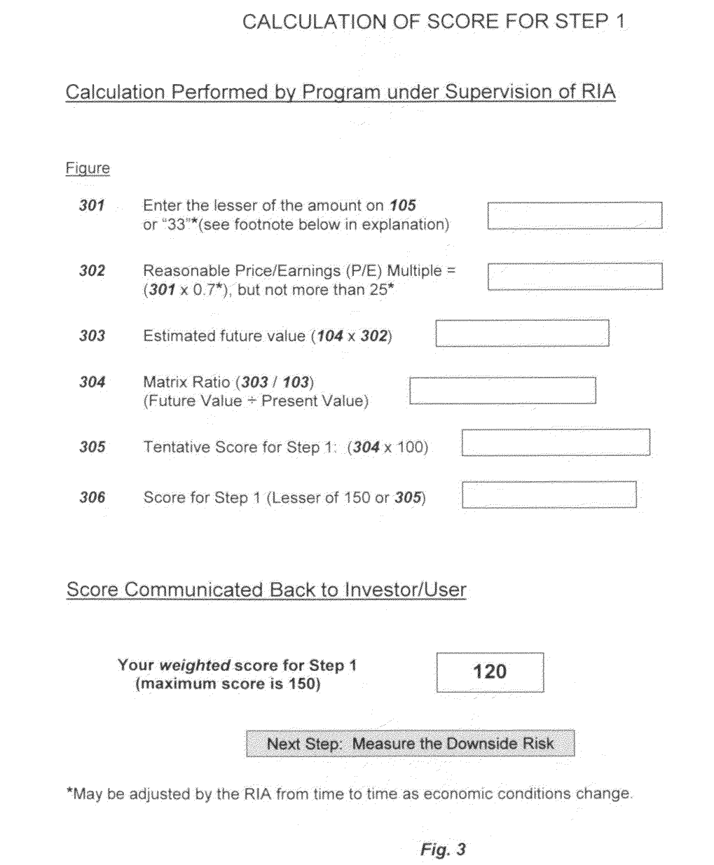

After filling in the information requested, the User/Investor clicks on the box marked “Calculate Step 1.” Thereupon, the information is submitted to the server or other electronic device operated by the Registered Investment Advisor, which, in turn, makes the necessary calculations, utilizing the interactive software program's algorithm, and responds back with a score, as shown in the bottom of FIG. 3 labeled “Your weighted score for Step 1: (maximum score is 150).”

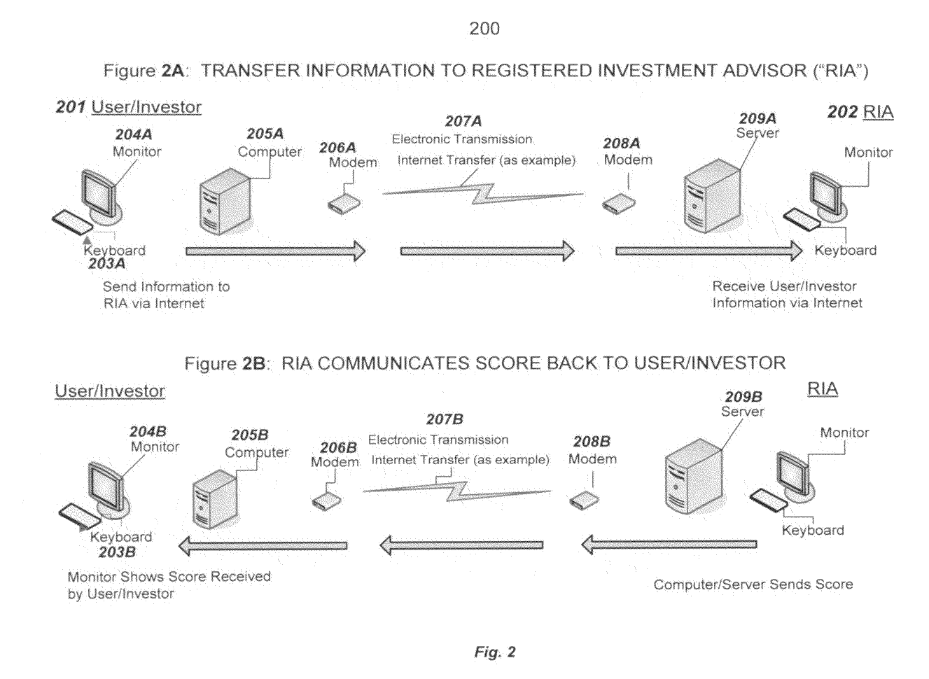

FIG. 2A shows the transfer of information from the User/Investor to the Registered Investment Advisor's server. FIG. 2B shows the transmission of information from the Registered Investment Advisor's server back to the website or directly, where it can be viewed by the User/Investor.

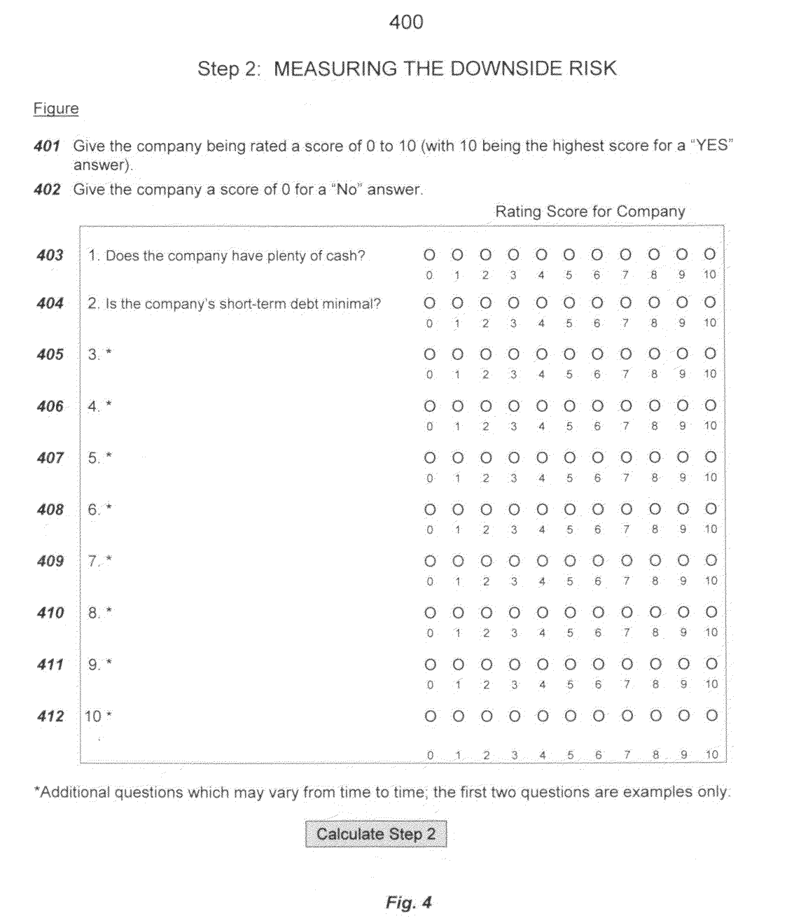

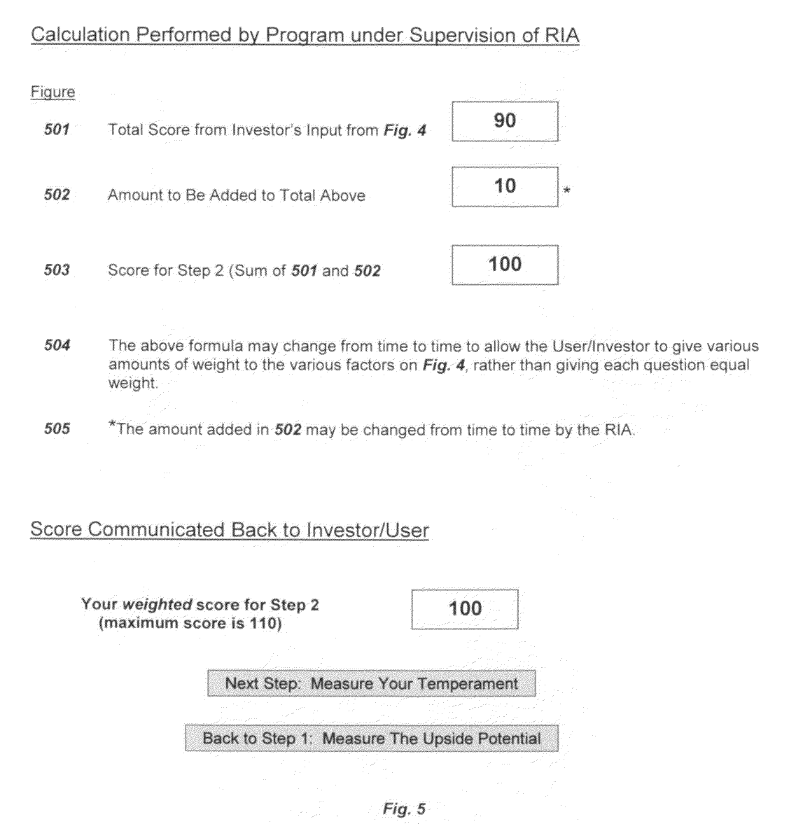

Thereupon, the User/Investor clicks on the box entitled, “Next Step: Measure the Downside Risk” (FIG. 3). Thereupon, a form appears on the Registered Investment Advisor's website for the User/Investor to fill out, such form being shown as FIG. 4. The User/Investor is asked to rate the score for the targeted company by clicking on a circle indicating a score from zero through ten for each of ten categories. The number of categories and the questions asked in each of the categories may vary from time to time. When the User/Investor has completed the form shown on FIG. 4, the User/Investor is asked to click on the box marked, “Calculate Step 2.” Thereupon, the information provided by the investor is submitted to the server or other electronic device operated by the Registered Investment Advisor, which thereupon makes the necessary calculations, utilizing the second formula (FIG. 5) in the algorithm, and responds back to the User/Investor with a weighted score for Step 2 as shown in box labeled “Your weighted score for Step 2: (maximum score is 110).”

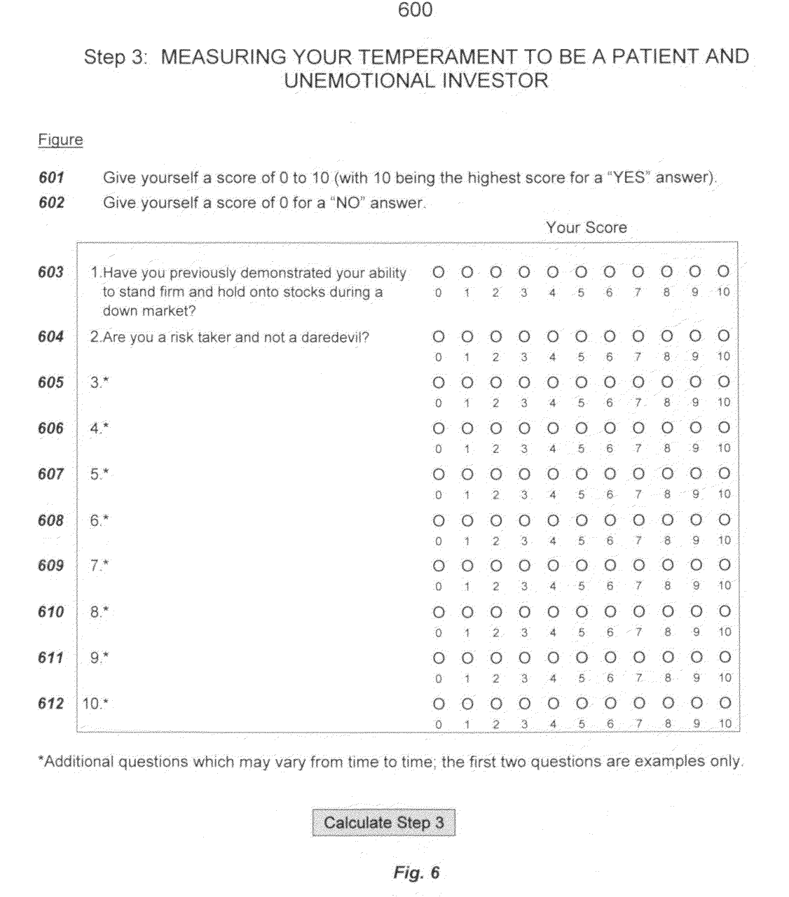

Thereupon, the User/Investor will click on the box marked “Next Step: Measure Your Temperament” (FIG. 5). Thereupon, FIG. 6 appears on the User/Investor's monitor. The User/Investor is then asked to fill in the circles to give scores to each of the questions in Step 3 as shown on FIG. 6. Note that the number of questions, the variety of questions, the nature of the questions, the wording of the questions and the subject matter of the questions may vary from time to time.

The responses to Step 3 are sent to the server or other electronic device of the Registered Investment Advisor, which thereupon renders the necessary calculations under the invention to respond to the User/Investor and to reflect a score in the box marked, “Your weighted score for Step 3: (maximum score is 110).” In the example shown, the current method for calculating that score is by adding up the numbers for the scores in Step 3 and adding the number 10 to the score before inserting it in the box marked “Your weighted score for Step 3: (maximum score is 110).”]’

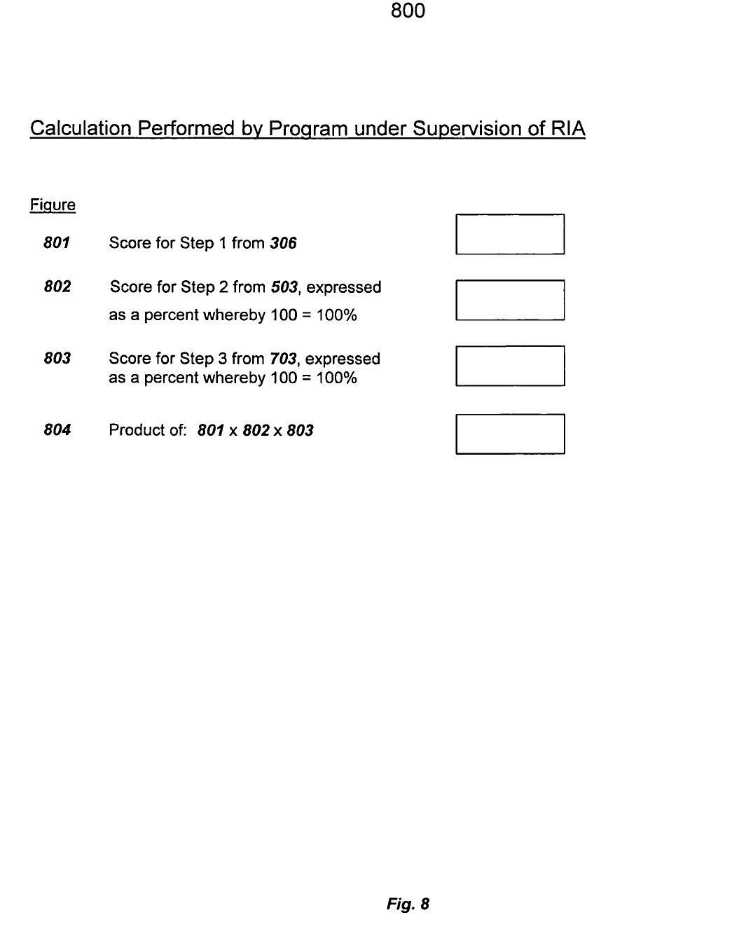

The next step is for the User/Investor to click on the box marked “Next Step: Your Stock Score and Rating” (FIG. 8). Thereupon, the scores for all three steps are inserted as shown in FIGS. 801, 802, and 803, along with the stock symbol in the first box. The weighted score is shown as FIG. 804, which is scored by multiplying the Step 1 score by the Step 2 score by the Step 3 score.

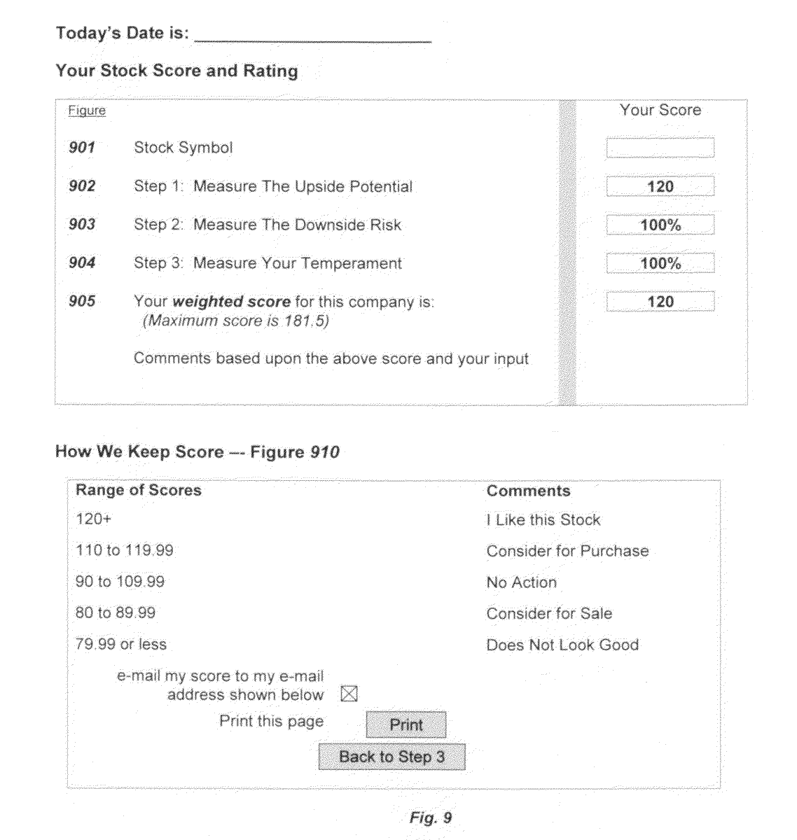

At the bottom of FIG. 9 appears “How we keep score” to indicate what the recommended action might be.

### DETAILED DESCRIPTION OF THE DRAWINGS

Referring to FIG. 1, the system 100 measures the upside potential of a given Targeted Stock to be evaluated.

FIG. 1 shows part of the process for measuring the upside potential of a Targeted Stock chosen by the User/Investor. It requires the User/Investor to respond with certain information regarding the Targeted Stock.

FIG. 101 asks for today's date.

FIG. 102 asks the User/Investor to enter a stock symbol for the Targeted Stock.

FIG. 103 asks the User/Investor to insert the current stock price or the proposed purchase price.

FIG. 104 asks the User/Investor to enter the estimated earnings per share (EPS) for the subsequent year.

FIG. 105 asks the User/Investor to enter the average estimated percentage increase in EPS each year for the next five years (inserting a whole number without inserting the percent (%) sign, the whole number representing the percentage increase per year). For example, 30% would be entered as “30.”

FIG. 106 asks the User/Investor to insert his or her first name.

FIG. 107 asks the User/Investor to enter his or her e-mail address.

FIG. 108 asks the User/Investor to confirm his or her e-mail address (by entering it again).

FIG. 109 requires the User/Investor to enter the state of residence (which may be required for SEC purposes).

FIG. 110 asks the User/Investor to confirm that he or she has read the instructions, understands the risks, and agrees to the terms of use and privacy policy.

Referring to FIG. 2A, the system reflects the transfer of Step 1 information from the User/Investor to the Registered Investment Advisor via the internet or other medium.

FIG. 201 on the left side reflects the electronic devices utilized by the User/Investor; the right side, FIG. 202, reflects the electronic devices utilized by the Registered Investment Advisor.

FIG. 2A requires the User/Investor's consent to proceed to calculate Step 1. The information is entered via the keyboard (FIG. 203A) and monitor (FIG. 209A) into the User/Investor's computer (FIG. 205A). It is thereafter transferred through the modem (FIG. 206A) through the internet (FIG. 207A) through the modem of the Registered Investment Advisor (FIG. 208A), and from there to the server of the Registered Investment Advisor (FIG. 209A) for further calculations.

Referring to FIG. 3, the system 300 reflects the calculation of the score for Step 1 by the Registered Investment Advisor's computer. The responses to the questions raised in FIGS. 101 through 110 are transferred to the Registered Investment Advisor's server, based on the responses provided by the User/Investor.

Thereupon, the following additional calculations are made.

FIG. 301 reflects the insertion of the lesser of the amount per FIG. 105 and the whole number 33. The whole number 33 may be adjusted by the Registered Investment Advisor as economic conditions change.

FIG. 302 reflects a reasonable price/earnings (P/E) multiple (Amount from FIG. 301 times 0.7) (but not more than 25). The 0.7 and the 25 may be adjusted by the Registered Investment Advisor from time to time as economic conditions change.

FIG. 303 reflects the computer's calculation of the future value of the stock, based upon the answers shown in FIG. 104 multiplied by the amount shown in FIG. 302.

FIG. 304 reflects a matrix ratio based upon the amount in FIG. 303 divided by the amount in FIG. 103.

FIG. 305 reflects the tentative score for Step 1, which is the amount in FIG. 304 multiplied by 100.

FIG. 306 reflects the score for Step 1, which is the lesser of the whole number 150 or the amount shown in FIG. 305 (amount shown in box immediately above).

FIG. 2B the system reflects the communication of the score for Step 1 (FIG. 306) from the computer or server of the Registered Investment Advisor (FIG. 209B) back to the User/Investor from the Registered Investment Advisor, through the modem of the Registered Investment Advisor (FIG. 208B) and thereupon via the interne (FIG. 207B) on through the modem (FIG. 206B) and computer (FIG. 205B) of the User/Investor and then to the monitor of the User/Investor (FIG. 204B).

Referring to FIG. 4, the system 400 reflects the measurement of the downside risk.

FIG. 401 provides instructions to the User/Investor.

FIG. 402 provides additional instructions.

FIG. 403 starts a series of questions, beginning with the first question.

FIG. 404 is the second question.

FIGS. 405 through 412 reflect additional questions to the User/Investor, which may vary from time to time.

FIG. 2A, the system 200, reflects the transfer of Step 2 information to the Registered Investment Advisor's computer. The User/Investor's electronic devices are on the left side, and the Registered Investment Advisor's electronic devices are on the right side. The User/Investor asks the Registered Investment Advisor to calculate Step 2 and send that information back via the internet (FIG. 207B). The information is entered on the keyboard (FIG. 203A) and is reflected on the monitor (FIG. 204A) and is run through the computer (FIG. 205A) on through the modem (FIG. 206A) and via the internet (FIG. 207A) through the modem of the Registered Investment Advisor (FIG. 208A) into the computer or server of the Registered Investment Advisor (FIG. 209A).

Calculation of the score for Step 2 by the Registered Investment Advisor's computer or server is reflected in FIG. 5, the system 500.

FIG. 501 reflects the total score from the User/Investor's input (FIG. 4).

FIG. 502 inserts 10 additional points to the score in FIG. 501. The number of points to be added may vary from time to time, depending on economic circumstances.

FIG. 503 is the score for Step 2, based on the sum of the numbers in FIGS. 501 and 502.

FIG. 504 is the footnote indicating that the Registered Investment Advisor may change the formula from time to time to allow the User/Investor to give various amounts of weight to various factors, rather than giving each factor equal weight.

FIG. 505 is the footnote which indicates the amount added in 502 may be changed from time to time by the Registered Investment Advisor.

FIG. 2B the system reflects the communication of the score for Step 2 (FIG. 503) from the computer or server of the Registered Investment Advisor (FIG. 209B) back to the User/Investor from the Registered Investment Advisor, through the modem of the Registered Investment Advisor (FIG. 208B) and thereupon via the interne (FIG. 207B) on through the modem (FIG. 206B) and computer (FIG. 205B) of the User/Investor and then to the monitor of the User/Investor (FIG. 204B).

FIG. 6, the system 600, is Step 3, a questionnaire for use in Step 3 as a method for measuring the temperament of the User/Investor.

FIG. 601 provides instructions to the User/Investor.

FIG. 602 provides additional instructions.

FIG. 603 starts a series of questions, beginning with the first question.

FIG. 604 is the second question.

FIGS. 605 through 612 reflect additional questions to the User/Investor, which may vary from time to time.

FIG. 2A, the system 200, reflects the transfer of Step 3 information to the Registered Investment Advisor's computer. The User/Investor's electronic devices are on the left side, and the Registered Investment Advisor's electronic devices are on the right side. The User/Investor asks the Registered Investment Advisor to calculate Step 3 and send that information back via the internet (FIG. 207B). The information is entered on the keyboard (FIG. 203A) and is reflected on the monitor (FIG. 204A) and is run through the computer (FIG. 205A) on through the modem (FIG. 206A) and via the internet (FIG. 207A) through the modem of the Registered Investment Advisor (FIG. 208A) into the computer or server of the Registered Investment Advisor (FIG. 209A).

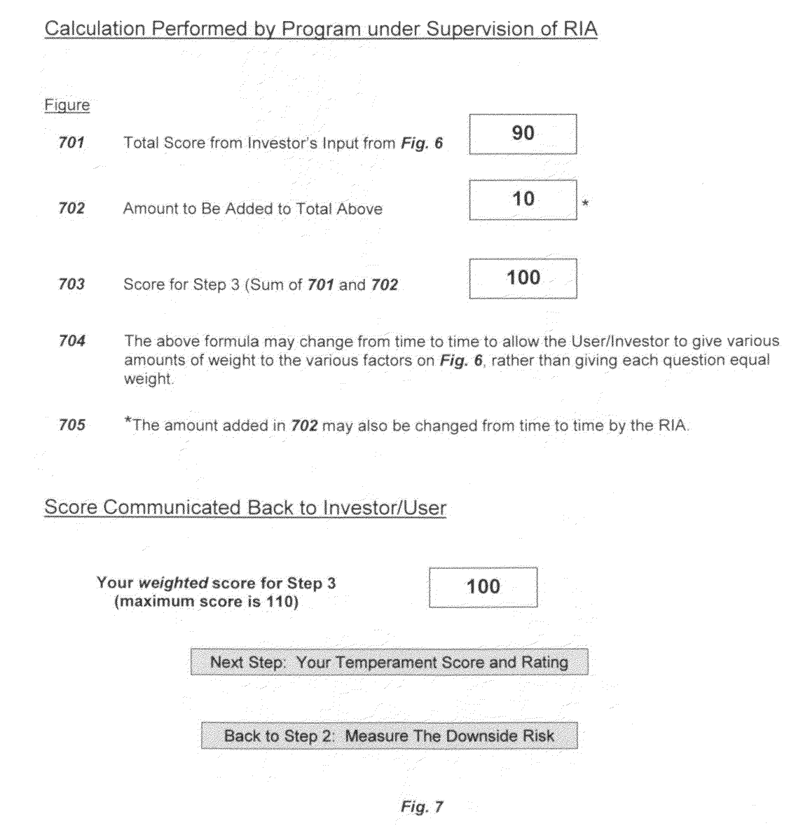

FIG. 7, the system 700 “Calculating the Score for Step 3” is the formula for measuring the temperament of the User/Investor to be a patient and unemotional investor, using the invention. Such adjustment may vary from time to time, depending on economic conditions.

FIG. 701 reflects the total score from the User/Investor's input (FIG. 6).

FIG. 702 inserts 10 additional points to the score in FIG. 701. The number of points to be added may vary from time to time, depending on economic circumstances.

FIG. 703 is the score for Step 2, based on the sum of the numbers in FIGS. 701 and 702.

FIG. 704 is the footnote indicating that the Registered Investment Advisor may change the formula from time to time to allow the User/Investor to give various amounts of weight to various factors, rather than giving each factor equal weight.

FIG. 705 is the footnote which indicates the amount added in 702 may be changed from time to time by the Registered Investment Advisor.

FIG. 2B the system reflects the communication of the score for Step 3 (FIG. 703) from the computer or server of the Registered Investment Advisor (FIG. 209B) back to the User/Investor from the Registered Investment Advisor, through the modem of the Registered Investment Advisor (FIG. 208B) and thereupon via the interne (FIG. 207B) on through the modem (FIG. 206B) and computer (FIG. 205B) of the User/Investor and then to the monitor of the User/Investor (FIG. 204B).

FIG. 8, the system 800, reflects the calculation of the weighted score for the stock.

FIG. 801 reflects the score shown in FIG. 306 as the score for Step 1.

FIG. 802 reflects the score shown in FIG. 503 as the score for Step 2.

FIG. 803 reflects the score shown in FIG. 703 as the score for Step 3.

FIG. 804 reflects the calculation, which is the amount shown in FIG. 801 times the amount shown in FIG. 802 times the amount shown in FIG. 803, with the result shown as FIG. 804.

FIG. 9, system 900, reflects the summary, “Your Stock Score and Rating”.

FIG. 901 is the stock symbol from FIG. 102.

FIG. 902 reflects the result of Step 1 as shown in FIG. 801.

FIG. 903 reflects the result of Step 2 as shown in FIG. 802.

FIG. 904 reflects the result of Step 3 as shown in FIG. 803.

FIG. 905 reflects the result as shown in FIG. 804.

The maximum score allowed is 181.5, and that is reflected as a maximum in FIG. 905.

FIG. 910 reflects how we keep score and the range of scores and the comments that would be applicable within those various ranges.

FIG. 2B the system reflects the communication of the weighted score (FIG. 905), along with the information in FIGS. 901, 902, 903 and 904 from the computer or server of the Registered Investment Advisor (FIG. 209B) back to the User/Investor from the Registered Investment Advisor, through the modem of the Registered Investment Advisor (FIG. 208B) and thereupon via the interne (FIG. 207B) on through the modem (FIG. 206B) and computer (FIG. 205B) of the User/Investor and then to the monitor of the User/Investor (FIG. 204B).

In addition, the method of keeping score, FIG. 910, is also sent back to the User/Investor as indicated in FIG. 2B.

### CONCLUSION

In summary, the claimed invention produces a useful, concrete and tangible result. It has a practical application and satisfies the utility requirement of 35 U.S.C. 101.

In addition, the claimed invention solves a significant problem that is not resolved in the prior art.

It is useful to User/Investors who desire an “investment coach” to help them analyze the pros and cons of investing in a particular stock. Rather than making a recommendation devoid of the User/Investor's input, the claimed invention is based almost entirely upon detailed questioning of the User/Investor, not only as to the particular stock, its upside potential and its downside risk, but also as to the User/Investor's temperament for being in the market. No prior art has been found which makes use of all the previously described inputs from the User/Investor as necessary ingredients and attains all of the above-described goals, along with recommendations from a Registered Investment Advisor.

In addition, the applicant has found no patent which provides automated computerized responses from a Registered Investment Advisor, based upon individualized information from the User/Investor in order to provide recommendations that take into consideration the User/Investor's self-evaluation of his or her determination of the estimated future earnings per share, the reasonableness of the price, the upside potential, the downside risk, and the temperament of the User/Investor, all with guidance from the Registered Investment Advisor.

1-19. (canceled)

20. A non-transitory computer readable storage medium with a computer program stored thereon for providing market investment information to a user for an individual stock, wherein the computer program instructs a processor to perform the following steps:
receive, from a user, a selection of at least one stock the user requests to be analyzed, wherein said selected stock is a targeted stock;
obtain a current stock price (CSP) of the targeted stock;
receive, from the user, an estimated earnings per share (EPS) of the targeted stock and for the next year;
receive, from the user, an estimated increase in the EPS each year for a plurality of years;
calculate a first score for the targeted stock, wherein the first score is based on at least the following items of information: the EPS, the estimated increase in the EPS each year for a plurality of years, and a future market value of the stock;
present, to the user, at least one question related to a risk associated with investing in the targeted stock;
receive, from the user, the user's response to the at least one question related to a risk associated with investing in the targeted stock;
calculate a second score that is based on the user's response to the at least one question related to a risk associated with investing in the targeted stock;
calculate a third score for the targeted stock, wherein the third score is based on the calculated second score and a weighted value;
present, to the user, at least one question related to the user's investment history or preferences for accepting risk associated with investing in the stock market;
receive, from the user, at least one response to said at least one question related to the user's investment history or preferences for accepting risk associated with investing in the stock market;
calculate a fourth score for the targeted stock, wherein the fourth score is based on the user's investment history or preferences for accepting risk associated with investing in the stock market; and
calculate a fifth score for the targeted stock that represents a total stock score (TSS) and rating, wherein the fifth score is based on the first through fourth scores.

21. The computer readable medium of claim 20, wherein prior to receipt from the user of the selection of the targeted stock, the program instructs the processor to perform a screening process of a plurality of stocks or to receive information from a third-party vendor of screened stocks that have been evaluated based on financial data for each of the plurality of stocks.

22. The computer readable medium of claim 20, wherein the at least one question related to the user's investment history or preferences for accepting risk associated with investing in the stock market is selected from the group consisting of: the user's liquidity, the user's diversification, the user's years to retirement, and the user's preferences for accepting risk associated with market investment.

23. The computer readable medium of claim 20, wherein the weighted value associated with the third score is provided by a registered investment advisor.

24. The computer readable medium of claim 20, wherein the first score is calculated as follows:
determine variable a, which is the lesser amount of said estimated increase in the EPS each year for a plurality of years or the absolute value 33;
determine a price/earnings multiple (P/E) equal to a(0.7) but not more than 25;
calculate said future market value of the stock (FMV), wherein FMV=EPS(P/E);
determine a matrix ratio (MR) equal to FMV/CSP, wherein CSP is said current stock price;
calculate a tentative first score (TFS)=MR(100); and
calculate the first score (FirstS), which is equal to the lesser of 150 or TFS.

25. The computer readable medium of claim 24, wherein the second score (SecondS) is a numerical value compiled from the user's response to the at least one question related to a risk associated with investing in the targeted stock.

26. The computer readable medium of claim 25, wherein the third score (ThirdS) is calculated as follows:
SecondS+b, wherein b is said weighted value and is selected by a registered investment advisor.

27. The computer readable medium of claim 26, wherein the fourth score (FourthS) is a numerical value compiled from the user's response to the at least one question related to the user's investment history or preferences for accepting risk associated with investing in the stock market.

28. The computer readable medium of claim 27, wherein the fifth score, which is said total stock score (TSS), is calculated as follows:
TSS=FirstS(ThirdS)(FourthS), where the ThirdS and Fourth S are expressed as percentages.
